(19) United States
(12) Patent Application Publication
(10) Pub. No.: US 2014/0032317 A1
(43) Pub. Date: Jan. 30, 2014

(54) METHODS AND SYSTEMS FOR ONLINE SALES OF PRODUCTS SHOWN IN BROADCAST PROGRAMS

(71) Applicant: Seckin Gungor, Ankara (TR)

(72) Inventor: Seckin Gungor, Ankara (TR)

(21) Appl. No.: 13/557,177

(22) Filed: Jul. 24, 2012

(51) Int. Cl. G06Q 30/06; G06Q 30/02

(52) U.S. Cl. 705/14.51; 705/26.41; 705/26.63

(57) ABSTRACT

The invention relates to a sales and marketing method formed for providing equals of the products used in up-to-date programs broadcasted on TV, to consumers in a short time. The invention particularly relates to a sales and marketing method for publishing clothing, accessory, and furniture etc. products broadcasted on TV and seen by the viewers, on the internet site for a certain period by means of contacting the contracted sponsor companies and thus supplying these products to customers.

### TECHNICAL FIELD

The present invention relates to sale and marketing methods and electronic systems for supplying customers with products as seen on TV broadcast programs.

### BACKGROUND

Shopping that historically started by means of barter, become more of a need for people day by day. Nowadays, shopping opportunities have been improved incomparably to the past. Online shopping is a leading shopping opportunity. A customer can buy the desired products in an online environment and receive them after a certain time.

Nowadays, people spare quite a lot of time for shopping. Especially people working with a busy schedule can not even find time for shopping and go without this enjoyable activity.

Time and the use of time in the correct way have become very important for people. Therefore, it is required to save time and provide convenience for people during the shopping activity.

Although shopping has to be an enjoyable activity for people, the effort given in shopping and the resulting exhaustion and the stress occurring as a result of not being able to find the desired product effects health of people and makes shopping an exhaustive and stressful activity.

In conclusion, the need for an enjoyable sales method that prevents loss of time in order and inadequacy of known solutions have necessitated an improvement in the related technical field.

### SUMMARY

According to one aspect of the invention, in the most general sense, there is provided a sales and marketing method and an electronic system formed with this method. The method can comprise the steps of: the company makes selection among up-to-date programs, the company buys the copyright of the programs from the broadcasting company, the company takes the inventory of the products from the supplier, makes editing of the products found in the broadcasted program and transfers these to the internet site, and broadcaster shares the internet address on which the customer can procure the products with public (notification text, advertisement) while the customers are watching the broadcasted program etc.

The purpose of the invention is to minimize the time required for shopping. It is a sale and marketing method and an electronic system formed with this method facilitating shopping for people who work with busy schedule.

A purpose of one or more of the embodiments of the invention is to provide the consumers with the facility to reach all the products in demand through a single address by means of gathering the products found in up-to-date programs broadcasted in all TV channels on a single internet site.

Another purpose of one or more embodiments of the invention is to provide a sales and marketing method and an electronic system formed with this method in which the products used or worn by the actors/actresses playing in current TV series, advertisements etc. broadcasted programs are published on the internet site for a certain period of time and thus provides the consumers with the facility to procure the products in demand.

Another purpose of one or more embodiments of the invention is to save the time of people while doing shopping and provide any product seen in any up-to-date broadcasted program in various colors and various sizes.

Another purpose of one or more embodiments of the the invention is to provide the consumer with the facility to do shopping while staying at home and purchase any products he/she sees on TV. From this point, it can be considered as if shopping centers are found in the houses of people.

Another purpose of one or more embodiments of the invention is to transfer all up-to-date programs to the internet address in the form of photos and videos and thus provide the users with the facility to easily remember and procure the products in a short time. Another purpose of the invention is to provide markers on the products found in the photos transferred to the internet site and thus enable selection of the product to be purchased.

One or more of the embodiments of the invention will become a preferred method in the sales sector in its present state and with the benefits it offers in its present state. Therefore, it would provide a commercial success.

The structural and characteristic features of the invention and all advantages will be understood better in detailed descriptions with the figures given below and with reference to the figures, and therefore, the assessment should be made taking into account the said figures and detailed explanations.

According to another aspect, there is provided an electronic system for marketing and selling to consumers products as seen on TV broadcasted programs. The electronic system can comprise at least one data processor configured to: eceive shoot information on an up-to-date broadcasted program, edit the shot program and transfer in the form of scenes to the internet site of the company that would employ the system, mark of the products seen in the edited scenes with the help of markers, provide information to consumers about the way of procurement of the products seen in the broadcasted program, allow a consumer to access a site where he/she can procure the products and becomes a member, receive a consumer sign in entry in the relevant site receive consumer search instructions for the product he/she has seen on TV by means of criteria such as; selection of program name in the TV series section, real name of the character found in the program, name of the character found in the program, brand name of the product, selection of product in the category section, receive selection of the products found in the scenes with the help of markers by consumers, after selection is complete, receiving selection of the payment method by the consumer, after selection of the products with the help of markers , receive selection of color, size, and number etc. ,receive entry of the selected products into the cart, listing of the products, and giving information to the user about the amount required to be paid, receive entry of up-to-date delivery information by the consumer, and receive click of the confirm order button by the consumer and transmission of the information to the server.

According to another aspect, a method for marketing and selling to consumers products as seen on TV broadcasted programs can comprise the operation steps of: receiving in an electronic system TV shoot information on at least one product as shown in a TV broadcast program; publishing information on said at least one product on the internet for procurement by consumers; and receiving in said electronic system consumer instructions for procuring at least one of said products.

### BRIEF DESCRIPTION OF THE DRAWINGS

In order that the present invention may be more readily understood, reference will now be made to the accompanying drawings, in which:

FIG. 1 is a flow chart illustrating a sales and marketing method of the present invention according to one embodiment;

FIG. 2 is a visual representation of a sales and marketing method of the present invention according to one embodiment;

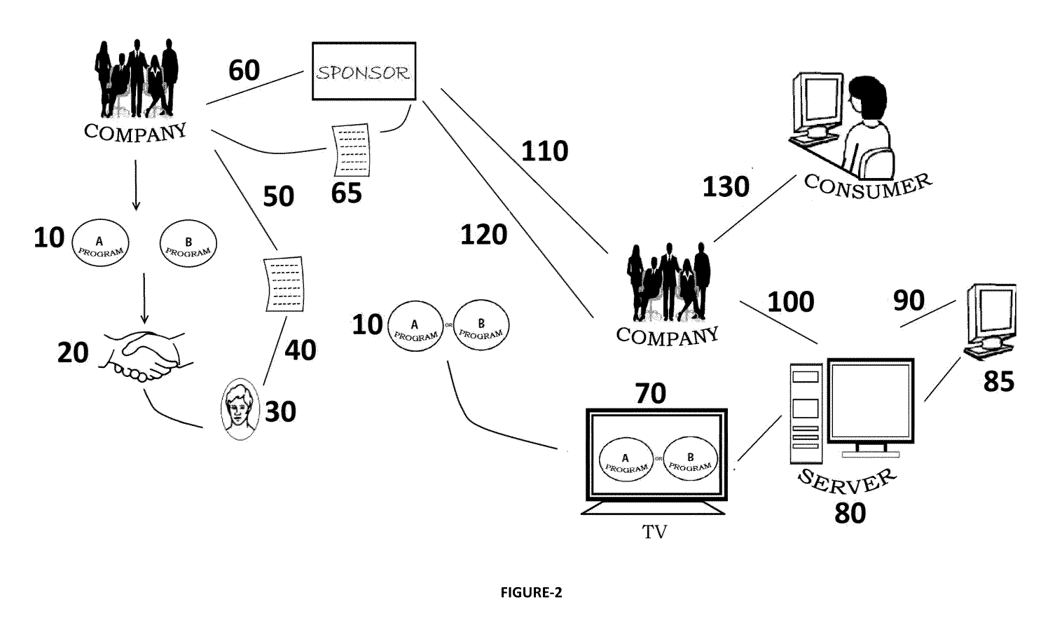

FIG. 3 is a flow chart describing the operation of a sales and marketing method of the present invention according to one embodiment;

FIG. 4 is a visual representation of the operation of a sales and marketing method of the present invention according to one embodiment; and

FIG. 5 is a visual representation of a sales and marketing method of the present invention according to one embodiment.

### REFERENCE NUMBERS

10. Selection of Program

20. Agreement with the Broadcasting Company

30. Agreement with the Costume Coordinator

40. Acquirement of the Information by the Costume Coordinator

50. Notification of the Company about the Information by the Costume Coordinator

60. Calling of the Sponsors and Demanding of the Product Inventory

65. Giving of the Inventory Information to the Company by the Sponsor

70. Broadcasting of the Program

80. Transfer of the Products to the Internet Site

85. Publishing of the Products for a Certain Time on the Internet Site

90. Determination of the Number of Products Sold at the Server

100. Gathering of the Server Information by the Company

110. Sending of the Information to the Sponsor Companies by the Company

120. Sending of the Products to the Company by the Sponsor Companies

130. Sending of the Product to the Customer by the Company

140. Shooting of Program

150. Editing and Transfer to the Internet Site

160. Marking of the Products via Markers

170. Informing of the Consumers

180. Signing up as a Member by the Consumer

190. Signing in the Relevant Internet Address by the Consumer

200. Searching of the Product in the Internet Site by the Consumer

210. Selection of the Products Found in the Scenes Transferred to the Internet Address by Using Markers

220. After Selection of the Product, Selection of the Payment Method

230. Selection of Numbers, Color, and Size

240. Entrance of the Selected Products into the Cart, Listing of the Products, and Informing the Consumer about the Amount Required to be Paid

250. Entrance of the Up-to-date Delivery Information by the Consumer

260. Confirm Order Button

270. Transfer to the Server

280. Reservation of the Demanded Products at the Server

290,300,310,320. Products

330. Consumer Sees the Product

340. Consumer Purchases the Product

A, B: Program Types

The invention would be better understood with the detailed description in reference to the above given reference numbers and the attached figures.

### DETAILED DESCRIPTION OF THE INVENTION

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Technical features described in this application can be used to construct various embodiments of methods and systems for methods and electronic systems for marketing and selling to consumers products as seen on TV broadcasted programs.

It has been identified that nowadays, a great deal of products are shared with the public through up-to-date TV series, advertisements etc. broadcast groups. Especially, people visit several shopping centers for buying products used or worn by actors/actresses playing in current TV series and can not find the product in demand as a result of this effort.

One embodiment of the invention relates to a sale and marketing method and an electronic system formed with this method for publishing clothing, accessory, and furniture etc. products broadcasted on TV and seen by the viewers, on the internet site for a certain period by means of contacting the contracted sponsor companies and thus supplying these products to customers.

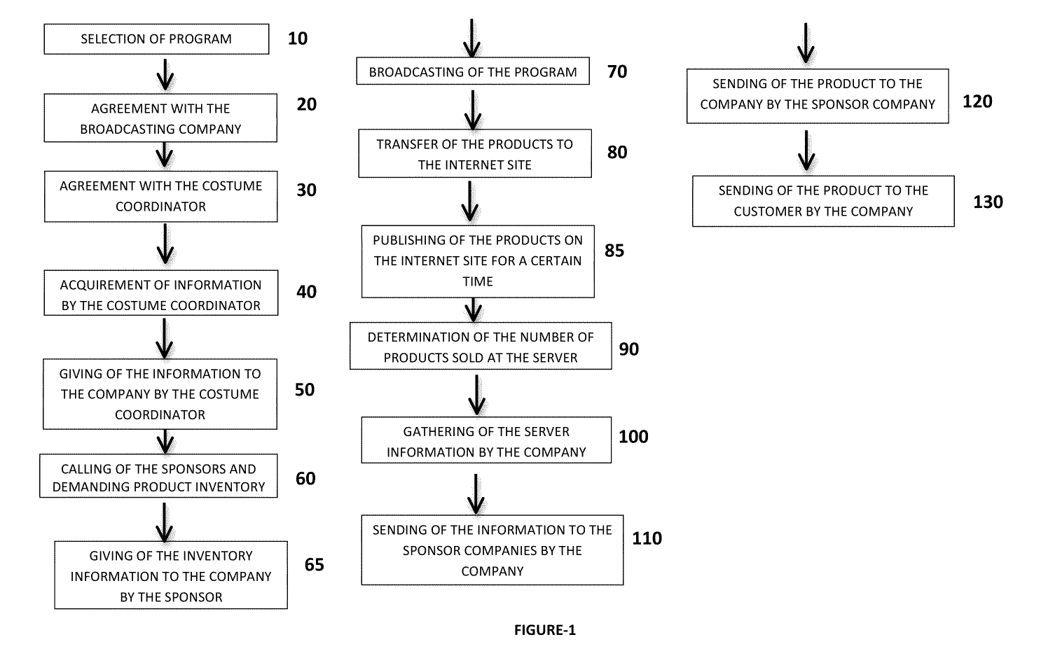

Referring to FIGS. 1 & 2 of the accompanying drawings, there is respectively illustrated a flow chart of a sales and marketing method and a visual representation of this flow chart according to one embodiment. General operation of the system is as follows: The company that will employ the system, firstly, makes a selection (10) of the programs drawing great interest among up-to-date broadcasted programs (A, B) and makes agreement (20) with the broadcasting company for the selected programs (A or B). After making agreement (20) with the broadcasting company, agreement is also made (30) with the costume coordinator of the relevant program (A or B). This agreement includes payment of the wage of costume coordinator by the company that would employ the system, which would normally be paid by the broadcaster company. As a result of making agreement (30) with the costume coordinator, the costume coordinator gathers the sponsor names, product (290, 300,310, 320) codes, and the name information of the characters found in the program (A or B) shot and then the costume coordinator gives this information to the company (50). The company calls the sponsors obtained from the costume coordinator and demands (60) the product (290, 300, 310, 320) inventory found in the broadcasted program (A or B). Afterwards, the sponsors inform (65) the company about the product (290, 300, 310, 320) inventory of the program (A or B) that has not been broadcasted yet. Then the program (A or B) is broadcasted (70) on TV and shared with the public. After broadcasting of the program (A or B), the company that would employ the system transfers (80) the products (290, 300, 310, 320) onto the internet site preferably in 1 or 2 days using the inventory (65) taken from the sponsor. Transferred products (290,300,310,320) are preferably published (85) for a certain period and sale is made to consumers on the internet site. After performing of the sales operation, the number of products (290, 300, 310, 320) purchased by consumers is determined in the server (90) and the information determined in the server is taken by the company (100). Gathered information is sent to the sponsor companies (110) by the company for procurement of the products (290, 300, 310, 320). According to the gathered information, sponsor companies send (120) the presently available products (290, 300, 310, 320) to the company. And the company then sends (130) the product (290, 300, 310, 320) sent by the sponsor company and thus sales operation is completed.

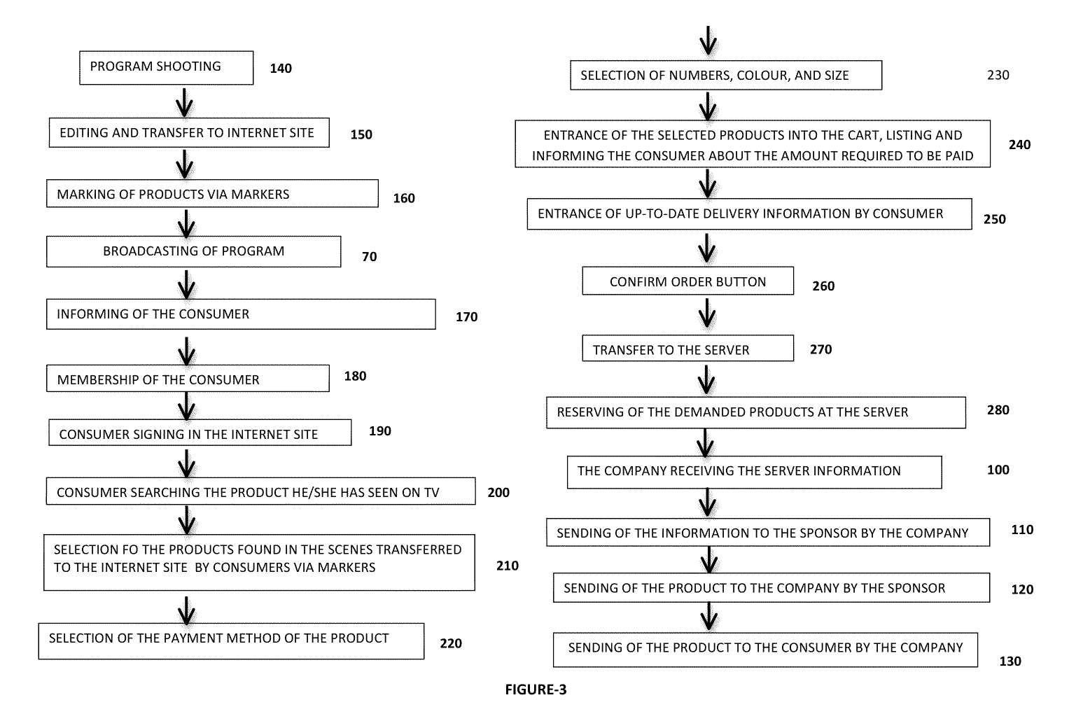

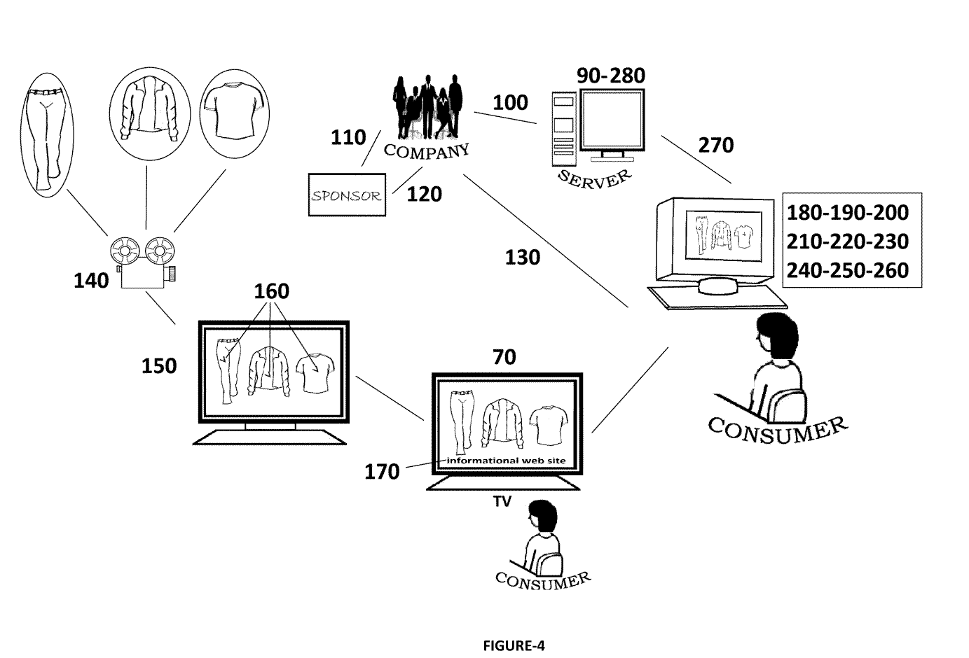

Referring now to FIGS. 3 and 4, there are respectively illustrated a flow chart and a visual representation of this flow chart describing operation of the sales and marketing method according to one embodiment. Shooting (140) of the program (A or B) is made by the broadcasting company and the scenes in the shot program are edited in the form of separate scenes and then transferred (150) to the internet site of the company that would employ the system. The same scenes found in the shot program are edited and transferred (150) to the internet site and the products (290, 300, 310, 320) seen in these scenes are marked by markers (160). Afterwards, the program is broadcasted (70) and information about a way of procurement of the products (A or B) shown in the broadcasted program (290, 300, 310, 320) is provided (170) to consumers by means advertisement of notification text. The consumer reaches the site from where he/she can procure the products (290, 300, 310, 320) and becomes a member (180). After the consumer signs up (180) to the site, then he/she signs in (190) the relevant site by entering his/her user name and password. Afterwards, the consumer searches the product (290, 300, 310, 320) he/she sees on TV in terms of various criteria (200). In order to find the relevant products (290, 300, 310, 320), consumer can make search among;
the program name in the TV series section
the real name of the character found in the program
the name of the character in the program
the brand name of the product (290, 300, 310, 320)
selection of product (290, 300, 310, 320) in the category section
   and thus tries to reach the relevant edited scenes. After the search, the products (290, 300, 310, 320) found in the reached scenes are selected (210) by the consumers with the help of markers and the consumer selects the payment method (220) after selecting the product. After selecting the products (290, 300, 310, 320) reached after the search with the help of markers (210), the consumer makes selection of color, size, number etc (230). After this step, selected products (290, 300, 310, 320) enter into the cart, are listed, and the consumer is informed about amount required to be paid (240) and entrance of up-to-date delivery information (250) is requested from the consumer. After entrance of up-to-date delivery information (250), the consumer clicks the confirm order button (260) and the information is transmitted to the server (270). Product (290, 300, 310, 320) information transmitted (270) to the server is reserved (280) at the server and the information found in the server is again taken by the company (100). The information taken is sent to the sponsor companies (110) by the company for procurement of the products (290, 300, 310, 320). In accordance with the information they receive, sponsor companies send the available products (290, 300, 310, 320) to the company (120). And the company sends (130) the product (290, 300, 310, 320) sent by the sponsor company to the consumer and thus sales operation is completed.

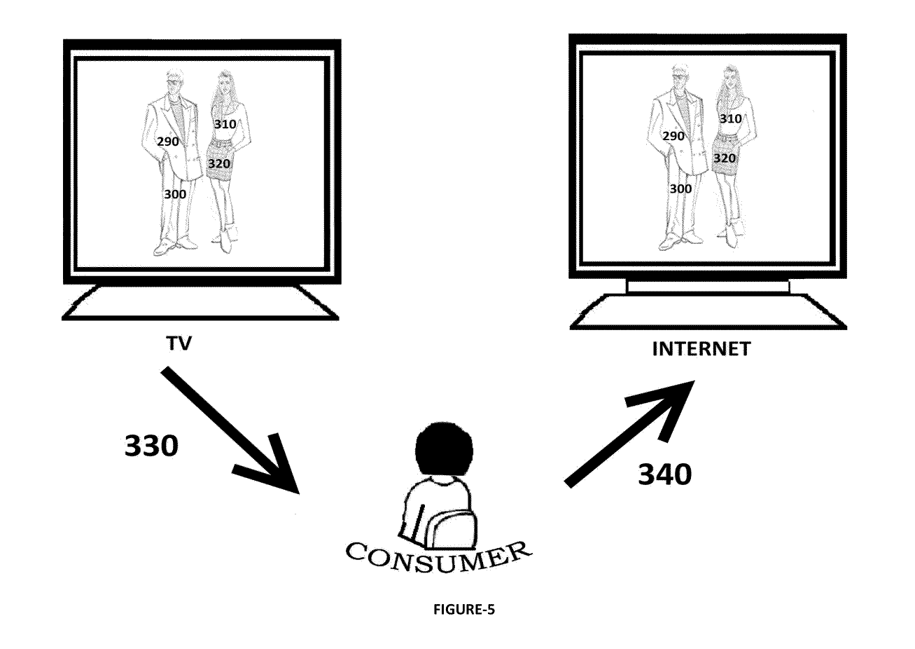

FIG. 5, is a visual representation describing the sales and marketing method according to one embodiment. Briefly, consumer purchases the products (290, 300, 310, 320) he/she sees on TV, through the internet and the sale operation is completed.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered.

1. A method for marketing and selling to consumers products as seen on TV broadcasted programs comprising the operation steps of:
a company making selection among up-to-date programs broadcasted on TV,
a company making agreement with a broadcasting company for the selected programs,
a company making agreement with the costume coordinator working in the broadcasting company,
a costume coordinator gathering the information about the products found in the program to be broadcasted on TV,
the costume coordinator giving the information about the products found in the program to be broadcasted on TV to the company,
demanding of the inventory of the products found in the broadcasted program from at least one sponsor,
the at least one sponsor giving the inventory of the products found in the broadcasted program to the company,
broadcasting of the program on TV,
after and/or substantially concurrently with broadcasting of the program, transferring products corresponding to the products found in the broadcast program to the internet site by the company by using the inventory taken from the sponsor,
publishing of the transferred products on the internet site for a certain period, after completion of the sales operation, determination of the number of products purchased by consumers in the server,
receiving of the information determined by the server by the company,
sending of the obtained information by the company to the sponsor companies in order to provide procurement of the products,
according to the received information, sending of the available products by the sponsor companies to the company, and
sending of the product sent by the sponsor company, to the consumer by the company.

2. A method for marketing and selling to consumers products as seen on broadcasted TV programs, the method comprising:
shooting of an up-to-date broadcasted program,
editing of the shot program and transferring in the form of scenes to the internet site of the company that would employ the system,
marking of the products seen in the edited scenes with the help of markers ,
providing information to consumers about the way of procurement of the products seen in the broadcasted program,
the consumer reaching the site where he/she can procure the products and becomes a member,
the consumer signing in the relevant site by entering his/her user name and password,
the consumer searching the product he/she has seen on TV by means of criteria such as;
selection of program name in the TV series section,
real name of the character found in the program,
name of the character found in the program,
brand name of the product,
selection of product in the category section,
selecting of the products found in the scenes with the help of markers by consumers,
after selection is complete, selecting the payment method by the consumer,
after selection of the products with the help of markers , selecting of color, size, and number etc.,
entering of the selected products into the cart, listing of the products, and giving information to the user about the amount required to be paid,
entering of up-to-date delivery information by the consumer, and
clicking of the confirm order button by the consumer and transmission of the information to the server.

3. The method of claim 2, wherein the editing of the said shot program and transferring in the form of scenes to the internet site of the company comprises editing of said shot program in the form of frames (photos) and videos and transferring in the form of frames (photos) and videos of scenes to the internet site of the company.

4. The method of claim 2, further comprising providing in the form of advertisement the information about the way of procurement of the products seen by the consumer .

5. The method of claim 2, further comprising providing in the form of notification text information about the way of procurement of the products seen by the consumer is provided in the form of notification text.

6. An electronic system for marketing and selling to consumers products as seen on TV broadcasted programs, the electronic system comprising a data processor configured to:
receive from a company a selection among up-to-date programs broadcasted on TV,
receive or make an agreement between the company and a broadcasting company for the selected programs,
receive or make an agreement between the company and the costume coordinator working in the broadcasting company,
gather from said costume coordinator the information about the products found in the program to be broadcasted on TV,
receive from the costume coordinate information about the products found in the program to be broadcasted on TV to the company,
demand the inventory of the products found in the broadcasted program from at least one sponsor,
receive from at least one sponsor the inventory of the products found in the broadcasted program to the company,
broadcast of the program on TV,
after and/or substantially concurrently with broadcasting of the program, transfer products corresponding to the products found in the broadcast program to the internet site by the company by using the inventory taken from the sponsor,
publish the transferred products on the internet site for a certain period,
after completion of the sales operation, determine the number of products purchased by consumers in the server,
receive the information determined by the server by the company,
send the obtained information by the company to the sponsor companies in order to provide procurement of the products,
according to the received information, receive information about the available products by the sponsor companies, and
execute sending of the product by the sponsor company, to the consumer by the company.
